(19) United States
(12) Patent Application Publication
(10) Pub. No.: US 2026/0003964 A1
(43) Pub. Date: Jan. 1, 2026

(54) STATE DETERMINATION DEVICE

(71) Applicant: HITACHI ASTEMO, LTD., Hitachinaka-shi, Ibaraki (JP)

(72) Inventors: Nobuyoshi MORITA, Chiyoda-ku, Tokyo (JP); Mikio KATAOKA, Chiyoda-ku, Tokyo (JP); Yasuhiro FUJII, Chiyoda-ku, Tokyo (JP); Teruaki NOMURA, Chiyoda-ku, Tokyo (JP)

(73) Assignee: HITACHI ASTEMO, LTD., Hitachinaka-shi, Ibaraki (JP)

(21) Appl. No.: 18/880,745

(22) PCT Filed: Mar. 13, 2023
(86) PCT No.: PCT/JP2023/009600

§ 371 Date: Jan. 2, 2025

(30) Foreign Application Priority Data
Jul. 19, 2022 (JP) 2022-114890

(51) Int. Cl. G06F 21/56

(52) U.S. Cl. CPC G06F 21/566; G06F 2221/034

(57) ABSTRACT

A state determination device is a state determination device which determines an abnormal state of an electronic control device mounted on a vehicle, the state determination device including: an extra-vehicular communication monitoring unit which monitors a presence or an absence of communication between the electronic control device and an outside of the vehicle; a code verification unit which executes code verification of the electronic control device; a device abnormality monitoring unit which monitors occurrence or non-occurrence of abnormality of the electronic control device; and an abnormality factor determination unit which determines a factor of an abnormality, wherein the abnormality factor determination unit identifies a factor of the abnormality based on a presence or an absence of communication, a result of the code verification, and existence or non-existence of the abnormality.

### TECHNICAL FIELD

The present invention relates to a state determination device that determines a state of an electronic control device mounted on a vehicle.

### BACKGROUND ART

In an electric control unit (ECU) mounted on a vehicle, when an abnormality related to a failure is detected, the event is stored as a log and used for cause analysis in an automobile company or a supplier. In addition, in recent years, a processing result of a security function mounted as a security measure is also required to be stored in the ECU as a log. In order to maintain the safety of the vehicle even after shipment, it is desirable to perform quick cause analysis by analyzing the log when a defect occurs in the vehicle in the market.

As a cause analysis technique in a case where a defect occurs in a vehicle, PTL 1 discloses a technique in which an in-vehicle control device stores a log with high priority and a server to which the log is transmitted analyzes the cause.

### CITATION LIST

### Patent Literature

PTL 1: WO 2021/144860 A

### SUMMARY OF INVENTION

### Technical Problem

In PTL 1, by considering the priority of logs, it is possible to store important logs over a long period of time even in a control device having no abundant resources. However, a method of identifying whether the occurrence factor of the defect is due to a failure or a cyberattack is not mentioned. For example, in a case where a defect related to a communication abnormality occurs, there is a possibility of a failure of a communication device, or a communication abnormality caused by a cyberattack. Actually, in a case where a measure is taken assuming a failure despite the cause of the cyberattack, investigation of the cause is delayed, and damage due to the cyberattack may expand. On the other hand, in a case where a measure assuming a cyberattack is taken even though the cause is actually a failure, unnecessary man-hours are required and the man-hour load increases.

The present invention has been made in view of the above problems, and an object of the present invention is to appropriately determine whether a factor of a defect that has occurred in a vehicle is a failure or a cyberattack, thereby dealing with the defect in the vehicle after the occurrence quickly and with appropriate man-hours.

Further features related to the present invention will become apparent from the description of the present specification and the accompanying drawings. Problems, configurations, and effects other than those described above will be clarified by the following description of embodiments.

### Solution to Problem

In order to solve the above problem, a state determination device according to an embodiment of the present invention is a state determination device which determines an abnormal state of an electronic control device mounted on a vehicle, the state determination device including: an extra-vehicular communication monitoring unit which monitors a presence or an absence of communication between the electronic control device and an outside of the vehicle; a code verification unit which executes code verification of the electronic control device; a device abnormality monitoring unit which monitors occurrence or non-occurrence of abnormality of the electronic control device; and an abnormality factor determination unit which determines a factor of an abnormality, wherein the abnormality factor determination unit identifies a factor of the abnormality based one a presence or an absence of communication, a result of the code verification, and existence or non-existence of the abnormality.

### Advantageous Effects of Invention

According to the present invention, in a case where an abnormality occurs, by storing, as a log, a result of determining whether a factor of the abnormality is a failure or a cyberattack, an analyst of the log can investigation of a cause based on the determination result. Therefore, it is possible to deal with the abnormality quickly and with appropriate man-hours after the occurrence of the defect of the vehicle.

Further features related to the present invention will become apparent from the description of the present specification and the accompanying drawings. Problems, configurations, and effects other than those described above will be clarified by the following description of embodiments.

### BRIEF DESCRIPTION OF DRAWINGS

FIG. 1 is a block diagram illustrating an example of a configuration of a state determination device according to an embodiment of the present invention.

FIG. 2 is a sequence diagram illustrating the entire processing executed by the state determination device.

FIG. 3 is a list of processing assumed in a case where an out-of-vehicle service is used.

FIG. 4 is a list of processing assumed in a case where an out-of-vehicle service is not used.

FIG. 5 is a flowchart illustrating processing in a case where a state determination device 1 determines a factor of an abnormality occurred in a monitoring target ECU.

FIG. 6 is a flowchart illustrating an outline of primary determination processing of an abnormality factor.

FIG. 7 is a flowchart illustrating an outline of secondary determination processing of an abnormality factor.

FIG. 8 is a diagram illustrating a data structure of a code verification result.

FIG. 9 is a diagram illustrating a data structure of a device abnormality log.

FIG. 10 is a diagram illustrating a data structure of an extra-vehicular communication history.

FIG. 11 is a diagram illustrating a data structure of an abnormality factor determination result.

FIG. 12 is a list of other processing assumed in a case where an out-of-vehicle service is not used.

### DESCRIPTION OF EMBODIMENTS

Hereinafter, embodiments of the present invention will be described in detail with reference to the drawings.

In the present embodiment, an example of a method of determining an occurrence factor of an abnormality based on abnormal log information acquired by an electronic control device mounted on a vehicle is used.

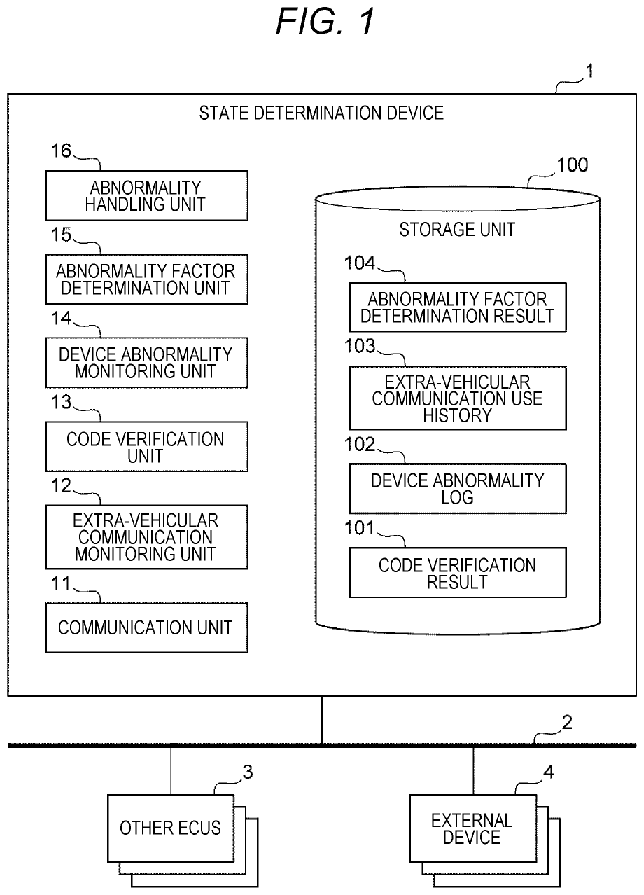

FIG. 1 illustrates a configuration of a state determination device according to an embodiment of the present invention. A state determination device 1 is, for example, an independent ECU mounted on a vehicle, and is connected to an other ECU 3 and an external device 4 via a communication bus 2. Note that the communication bus 2 is physically a plurality of communication buses, and the standards of these communication buses may be the same or different. These communication bus standards are CAN (registered trademark), LIN (registered trademark), FlexRay (registered trademark), Ethernet (registered trademark), and the like. Here, the other ECU 3 may be another ECU mounted on the vehicle, and the external device 4 may be, for example, a device such as a server device of a supplier that communicates with an in-vehicle ECU, and instructs update or the like.

The state determination device 1 includes a CPU (not illustrated), a ROM (not illustrated), and a RAM (not illustrated), and realizes the following functions by the CPU deploying a program stored in the ROM in the RAM and executing the program. Note that, although the state determination device 1 is an independent ECU in the above description, the state determination device 1 may be included in the monitoring target ECU itself, or may be configured as an independent ECU and determine states of a plurality of other monitoring target ECUs. That is, the relationship between the state determination device 1 and the ECU which is a monitoring target is not limited at all.

That is, the state determination device 1 includes, as its functions, a communication unit 11, an extra-vehicular communication monitoring unit 12, a code verification unit 13, a device abnormality monitoring unit 14, an abnormality factor determination unit 15, and an abnormality handling unit 16. In addition, the state determination device 1 includes a storage unit 100 which is a nonvolatile storage device.

The storage unit 100 stores a code verification result 101 storing a code verification result of the state determination device 1, a device abnormality log 102 storing a log related to an abnormality in the state determination device 1, an extra-vehicular communication use history 103 storing a use history of extra-vehicular communication, and an abnormality factor determination result 104 storing a determination result of an occurrence factor of an abnormality.

The communication unit 11 is a communication interface and is a functional unit which performs calculation necessary for communication, and transmits and receives messages relative to another ECU 3 or the external device 4 via the communication bus 2. As described above, the communication bus 2 physically includes a plurality of communication buses. The state determination device 1 can collect information by which an abnormal state of each device can be determined using the communication unit 11.

The extra-vehicular communication monitoring unit 12 monitors use of an API (application programming interface) related to extra-vehicular communication provided by the state determination device 1, and registers a use record in the storage unit 100 as an extra-vehicular communication use history 103. The API may include an API related to extra-vehicular communication specified in advance even if the API is not directly related to the extra-vehicular communication. The code verification unit 13 verifies existence or non-existence of tampering of a program executed in the state determination device 1 at a predetermined timing, and registers the verification result in the storage unit 100 as the code verification result 101. The device abnormality monitoring unit 14 monitors an abnormal event related to a processing result of the security function or a failure, and registers the monitoring result in the storage unit 100 as the device abnormality log 102. The abnormality factor determination unit 15 determines whether the factor of the device abnormality occurred is a failure or an attack based on the extra-vehicular communication use history 103, the device abnormality log 102, and the code verification result 101, and registers the determination result in the storage unit 100 as the abnormality factor determination result 104. The abnormality handling unit 16 determines and executes a handling content for an abnormality based on the abnormality factor determination result 104.

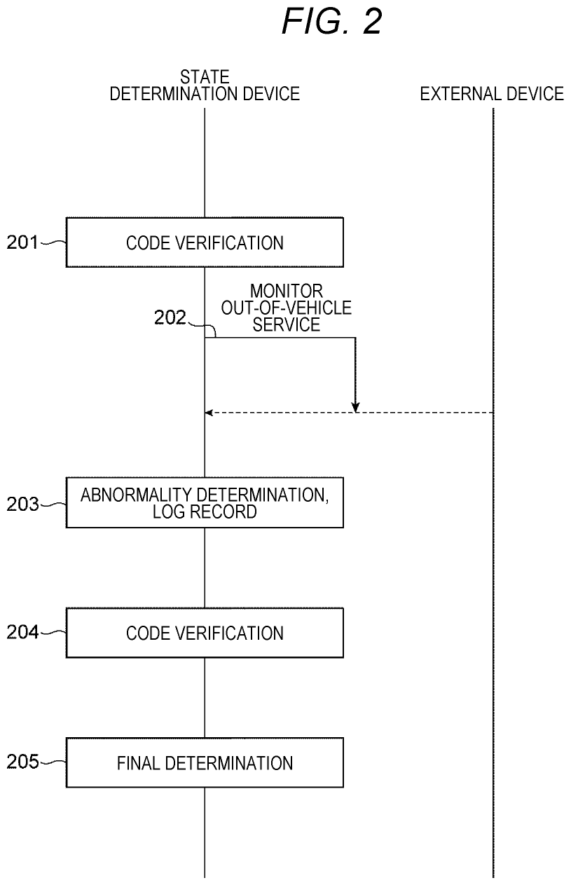

FIG. 2 is a sequence diagram illustrating the entire processing executed by the state determination device 1. As illustrated in FIG. 2, first, the state determination device 1 issues a code verification instruction signal to the code verification unit 13 at the time of activation or after a lapse of a predetermined time after activation, and executes code verification (step 201). In a case where the code verification is successful, the extra-vehicular communication monitoring unit 12 of the state determination device 1 continues to monitor whether or not an out-of-vehicle service is provided from the external device 4 (step 202). In parallel, the device abnormality monitoring unit 14 monitors whether or not an abnormality has occurred in the monitoring target ECU, and stores the abnormality in the storage unit 100 as the device abnormality log 102 in a case where an abnormality is detected (step 203).

Thereafter, at the time of restart or after a lapse of a predetermined time, a code verification instruction signal is issued to the code verification unit 13 again to execute code verification (step 204). Then, finally, the abnormality factor determination unit 15 determines a factor in a case where an abnormality is detected (step 205).

As described above, in short, the state determination device 1 according to the present invention executes, as needed, code verification such as secure boot at the time of activation, monitoring of a presence or an absence of provision of an out-of-vehicle service from the external device 4, and monitoring of whether or not an abnormality has occurred in the monitoring target ECU. Then, based on these results, an abnormality factor is determined as described in detail below.

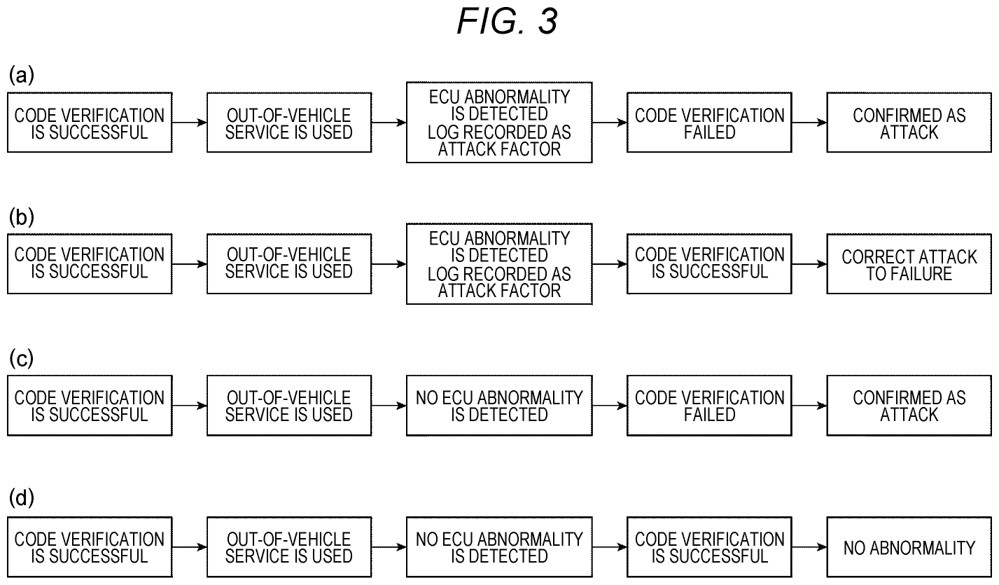

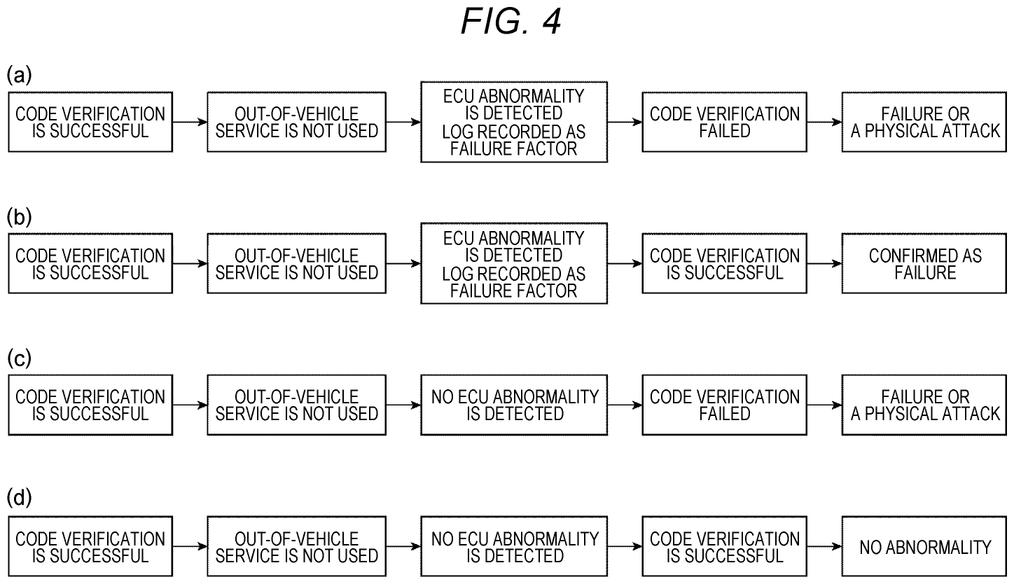

Details of a method for determining the state of the monitoring target ECU by the state determination device 1 will be described below with reference to FIGS. 3 and 4. FIG. 3 is a list in a case where the out-of-vehicle service from the external device 4 is used, and FIG. 4 is a list in a case where the out-of-vehicle service is not used.

As illustrated in FIG. 3, in a case where the out-of-vehicle service is used, it is classified into a case where the abnormality of the ECU is detected as illustrated in FIGS. 3(a) and 3(b) and a case where the abnormality of the ECU is not detected as illustrated in FIGS. 3(c) and 3(d).

First, as shown in FIGS. 3a) and 3(b), in a case where the extra-vehicular communication monitoring unit 12 determines that the monitoring target ECU uses the out-of-vehicle service from the external device 4, and thereafter, the device abnormality monitoring unit 14 detects the abnormality of the monitoring target ECU, code verification is executed again as described with reference to FIG. 2. In a case where the result is failure, the abnormality factor determination unit 15 determines that the abnormality occurred in the monitoring target ECU is caused by an external attack, as illustrated in FIG. 3(a). In a case where the code verification is successful, it is determined that the abnormality occurred in the monitoring target ECU is not caused by an external attack but caused by a failure, as illustrated in FIG. 3b).

Even in a case where the device abnormality monitoring unit 14 does not detect an abnormality in the monitoring target ECU, if the subsequent code verification fails, it is determined that the abnormality is caused by an attack, and if the code verification is successful, it is determined that no abnormality exists in the monitoring target ECU, as illustrated in FIGS. 3(c) and 3(d). The above determination is made for the following reasons.

That is, code verification represented by secure boot is highly reliable, and successful of the code verification means that no abnormality exists in the ECU. Therefore, in a case where the second code verification fails, it is considered that there is a very high possibility that the cyberattack has been received from the outside until then. From the above, in a case where the code verification executed again after the code verification is successful fails and the out-of-vehicle service is used during that time, it can be determined that a third party has caused the cyberattack on the monitoring target ECU using the out-of-vehicle service. However, as illustrated in FIG. 3(b), even if an abnormality occurs in the monitoring target ECU, if the subsequent code verification is successful, it is determined that the abnormality is highly likely to be caused by a failure of the monitoring target ECU.

FIG. 4 is a list of a case where the monitoring target ECU does not use the out-of-vehicle service, unlike the case of FIG. 3. In this case, a difference from FIG. 4 is that, even in a case where the device abnormality monitoring unit 14 detects an abnormality in the monitoring target ECU, the abnormality factor determination unit 15 once determines that the factor of the abnormality is not an attack but a failure. This is because, as described above, the reliability of code verification is high, and in a case where an abnormality is detected in a state where no external access is present after code verification has been successful once, it is considered that there is almost no possibility of receiving a cyberattack from the outside.

In a case where the code verification after the abnormality is detected in the monitoring target ECU fails, it is determined that there is a possibility that the abnormality is a failure due to a defect or the like of the memory storing the secure boot program or a direct physical attack is applied without through radio, as illustrated in FIG. 4(a). Here, the physical attack means direct unauthorized access to wiring or the like of the vehicle using a tool or the like. Since this physical attack is very difficult and does not immediately affect a large number of vehicles distributed in the market, it is managed as a risk factor similar to a failure. In a case where the code verification after the abnormality is detected in the monitoring target ECU is successful, it is determined that the abnormality is caused by a failure, as illustrated in FIG. 4(b).

Also in FIGS. 4(c) and 4(d), similarly to the above, in a case where the code verification executed again in a state where no abnormality is detected in the monitoring target ECU fails, it is determined that a memory failure or a physical attack has been applied, and in a case where the code verification is successful, it is determined that the monitoring target ECU has no abnormality.

FIG. 5 is a flowchart illustrating processing in a case where the state determination device 1 determines a factor of the abnormality occurred in the monitoring target ECU. An execution subject of each step described below is a CPU (not illustrated) of the state determination device 1.

In step 501, the code verification unit 13 verifies whether the program executed by the state determination device 1 has been tampered with, and registers the verification result in the storage unit 100 as the code verification result 101. Step 501 may be executed first when the monitoring target ECU is activated, or may be executed at any timing. In addition, the code verification method may be, for example, code verification using a common key such as AES-CMAC. The common key may be stored in advance in a region (for example, an HSM (hardware security module)) in which confidentiality and integrity are secured in the state determination device 1, an operation result of AES-CMAC may be compared with a verification expectation value stored in a region in which integrity is secured in advance based on a program of a verification target region and the common key, and it may be determined that the program has not been tampered when they match. In addition, code verification using a public key such as RSA or ECDSA may be used.

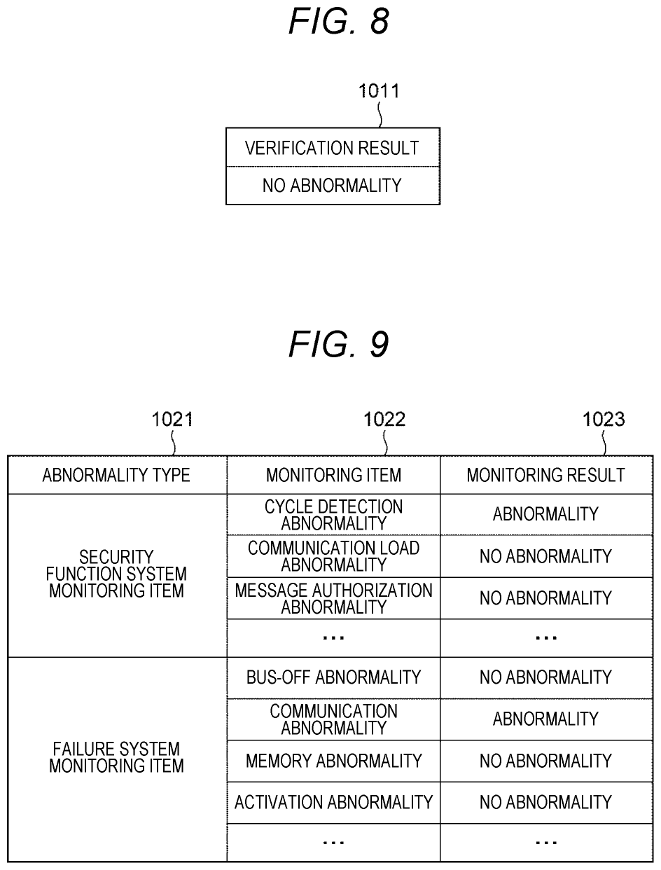

FIG. 8 illustrates an example of the code verification result 101 registered by the code verification unit 13 in step 501. The code verification result 101 stores information including the verification result 1011. For example, in a case where it is determined in the code verification that tampering exists, the verification result 1011 is determined to be abnormal, and in a case where it is determined in the code verification that no tampering exists, the verification result 1011 is determined to be no abnormality.

In step 502, the abnormality factor determination unit 15 determines whether or not a primary determination result is present. Although described in detail later, the primary determination is the content of the result in a case where the code verification executed so far has been successful and the monitoring by the extra-vehicular communication monitoring unit 12 has been performed. In a case where the primary determination result is present, the process proceeds to step 507, and in a case where no primary determination result is present, the process proceeds to step 503. For example, flag information indicating that the state determination device 1 has performed the primary determination may be stored. In a case where the flag indicates 1, it may be determined that the primary determination result is present, and in a case where the flag indicates 0, it may be determined that no primary determination result is present.

In step 503, the code verification unit 13 proceeds to step 505 in a case where it is determined in step 501 that no tampering (abnormality) exists, and proceeds to step 504 in a case where it is determined in step 501 that tampering (abnormality) exists.

Step 504 is a case where no primary determination result is present and the code verification indicates abnormal. This means that an abnormality has occurred at the time of first code verification, and thus the abnormality factor determination unit 15 determines a factor of an abnormality occurred in the monitoring target ECU as an initial operation defect. In a case where the ECU is activated even once when the ECU is produced in the factory, it can be ensured that the ECU is not attacked in a safe factory, and it can be determined that a defect exists in factory production such as a setting error of a program written to the ECU or a memory defect.

In step 505, the device abnormality monitoring unit 14 monitors the occurrence of abnormality in state determination device 1. In a case where an event indicating an abnormality as a processing result of the security function or an event indicating failure of the device is detected as an abnormality, it is determined that the device abnormality has occurred, and the event is registered in the storage unit 100 as the device abnormality log 102.

FIG. 9 illustrates an example of the device abnormality log 102 registered by the device abnormality monitoring unit 14 in step 505. The device abnormality log 102 stores information including an abnormality type 1021 for distinguishing whether a log is based on a monitoring item of a security function system or a log based on a failure system monitoring item as a type of log, a monitoring item 1022 indicating a monitoring content, and a monitoring result 1023 indicating existence or non-existence of an abnormality in each monitoring item. For example, in a case where a cycle detection function detects an abnormality, the monitoring result 1023 associated with the cycle detection abnormality of the monitoring item 1022 indicates that an abnormality exists.

In step 506, the abnormality factor determination unit 15 performs the primary determination based on the monitoring result of step 505 described above. Note that this step may also be performed when no abnormality is detected in step 505 described above.

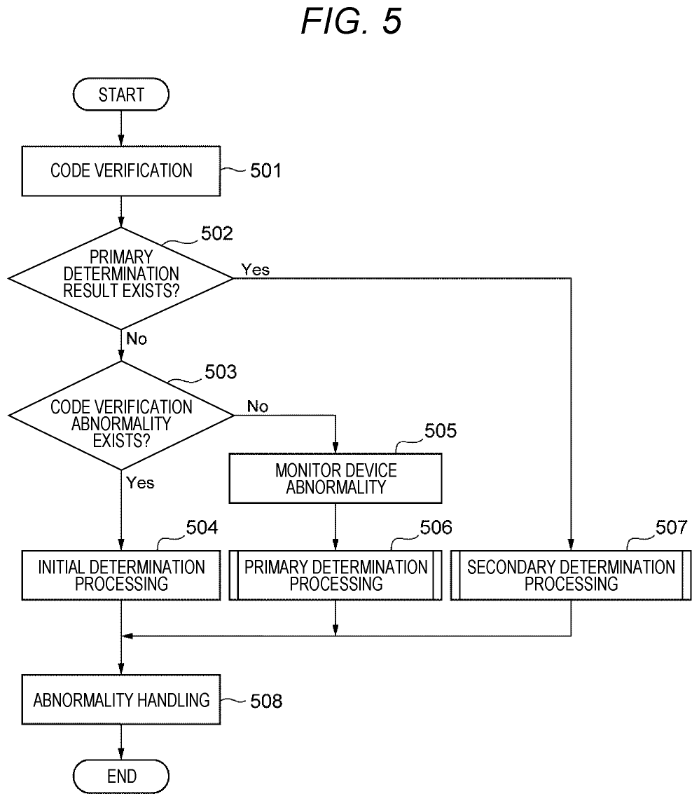

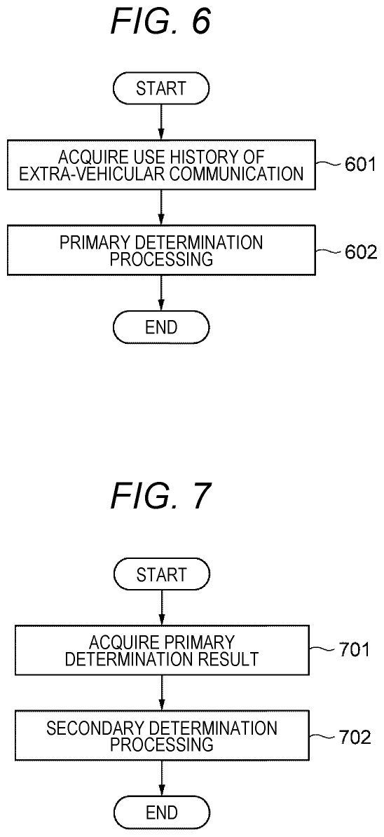

FIG. 6 illustrates a processing flow in which the abnormality factor determination unit 15 primarily determines an abnormality factor in step 506 described above. An execution subject of each step described below is a CPU (not illustrated) of the state determination device 1.

In step 601, the extra-vehicular communication monitoring unit 12 acquires a history of use of the extra-vehicular communication by the state determination device 1 from the extra-vehicular communication use history 103 of the storage unit 100. At this time, as the extra-vehicular communication history, only the extra-vehicular communication history for use after it is determined that no abnormality exists in the past code verification is recorded as a log.

FIG. 10 illustrates an example of an extra-vehicular communication use history 103 acquired by the extra-vehicular communication monitoring unit 12 in step 601 described above. The extra-vehicular communication use history 103 stores information including a monitoring item 1031 indicating an extra-vehicular communication item to be monitored and a use history 1032 registered as being used in a case where use of an API related to the monitoring item or transmission or reception of data is present. In addition to these information, a use time, the number of times of use, and the like may be included as a history, and accuracy of determination of information may be set based on these information.

In step 602, as the primary determination processing, the abnormality factor determination unit 15 determines an abnormality factor based on the presence or absence of extra-vehicular communication use and a device abnormality. Specifically, as described with reference to FIGS. 3 and 4, the abnormality factor determination unit 15 determines as a failure in a case where no use history of extra-vehicular communication is present and a device abnormality has occurred, and determines as an attack in a case where a use history of extra-vehicular communication is present and a device abnormality has occurred. In addition, the abnormality factor determination unit 15 determines that no abnormality exists in a case where a use history of extra-vehicular communication is present and no device abnormality has occurred, and also determines that no abnormality exists in a case where no use history of extra-vehicular communication is present and no device abnormality has occurred. In this way, the primary determination result is obtained.

In a case where it is determined in step 502 that a primary determination result is present, in step 507, the abnormality factor determination unit 15 performs secondary determination of an abnormality factor based on the above-described primary determination result.

FIG. 7 illustrates a processing flow in which the abnormality factor determination unit 15 secondarily determines an abnormality factor in step 507 described above. An execution subject of each step described below is a CPU (not illustrated) of the state determination device 1.

In step 701, the abnormality factor determination unit 15 acquires the primary determination result from the abnormality factor determination result 104 of the storage unit 100.

In step 702, the abnormality factor determination unit 15 performs secondary determination based on the code verification result in step 501 and the primary determination result acquired in step 701. Specifically, as described with reference to FIGS. 3 and 4, in a case where it is determined as an attack in the primary determination and it is determined that no abnormality exists in the latest code verification, the abnormality factor is updated to a failure. In a case where it is determined as an attack in the primary determination and it is determined that an abnormality exists in the latest code verification, the abnormality factor is determined as an attack. At this time, information indicating higher accuracy may be added to the log. In a case where it is determined as a failure in the primary determination and it is determined that no abnormality exists in the latest code verification, the abnormality factor is determined as a failure. At this time, information indicating a failure other than the memory-related failure may be added to the log.

In a case where it is determined as a failure in the primary determination and it is determined that an abnormality exists in the latest code verification, the abnormality factor is determined as a failure. At this time, information indicating a memory-related failure may be added to the log, or information indicating that the attack is a physical attack directly to the control device or through the communication bus 2 thereof may be added to the log. In a case where it is determined that no abnormality exists in the primary determination and it is determined that no abnormality exists in the latest code verification, the abnormality factor is determined as no abnormality. In a case where it is determined that no abnormality exists in the primary determination, it is determined that an abnormality exists in the latest code verification, and a use history of the out-of-vehicle service is present in a period in which the determination is changed from the absence of abnormality in the previous code verification to the presence of abnormality in the latest code verification, the abnormal factor is updated to an attack. In a case where it is determined that no abnormality exists in the primary determination, it is determined that an abnormality exists in the latest code verification, and no use history of the out-of-vehicle service is present in a period in which the determination is changed from the absence of abnormality in the previous code verification to the presence of abnormality in the latest code verification, the abnormal factor is updated to a failure.

Through the above steps, the state determination device 1 can determine whether the occurrence factor of the abnormality is an attack or a failure with higher accuracy by updating the primary determination result as necessary based on the latest code verification result and the primary determination result.

After any one of the first determination processing in step 504, the primary determination processing in step 506, and the secondary determination processing in step 507 is performed, the process proceeds to step 508. In step 508, the abnormality handling unit 16 registers the log in the storage unit 100 as the abnormality factor determination result 104 or notifies the apparatus outside the vehicle via the communication unit 11, based on the factor determination results in step 504, 506, or 507.

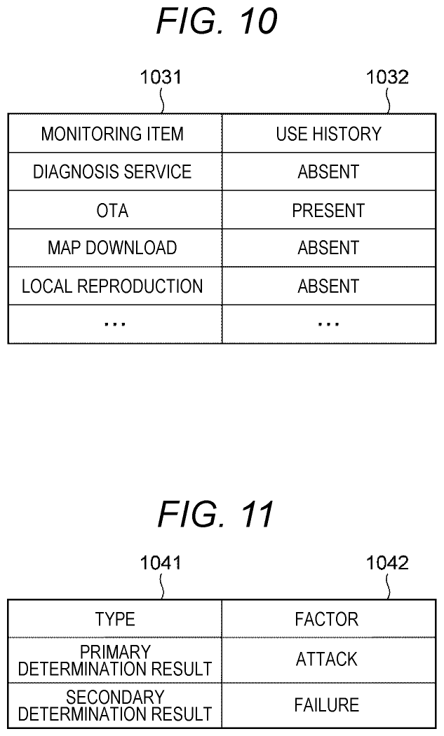

FIG. 11 illustrates an example of the abnormality factor determination result 104 registered by the abnormality handling unit 16 in step 508. The abnormality factor determination result 104 stores information including a type 1041 for distinguishing the primary determination processing result and the secondary determination processing result to be described later, and a factor 1042 indicating an abnormality occurrence factor. The information registered in the abnormality factor determination result 104 may be initialized by receiving a command from the outside, for example, at a timing when the occurred abnormality is resolved.

According to the present embodiment described above, the state determination device 1 can determine whether the occurrence factor of the abnormality is a failure or an attack based on the use history of the extra-vehicular communication and the occurrence of the device abnormality. In addition, since the analyst of the recorded log can investigate the cause based on the determination result, it is possible to deal with a defect of the vehicle quickly and with appropriate man-hours.

### Modification

Some modifications will be described below.

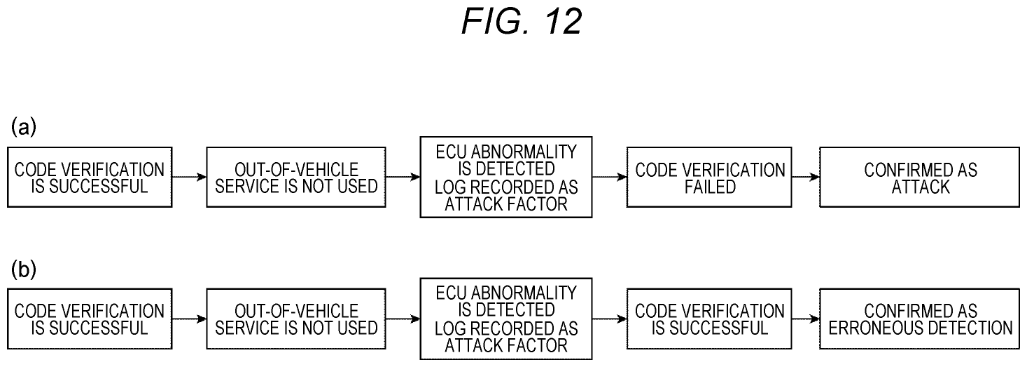

In the first embodiment described above, it is determined as failure factor in the primary determination in a case where the abnormality occurs in the monitoring target ECU while the out-of-vehicle service is not used (FIGS. 4(a) and 4(b)). However, as described with reference to FIG. 9, the abnormality type includes a security function system in addition to a failure system. Therefore, in the modification, in a case where the abnormality occurs in the security function system even though the out-of-vehicle service is not used, it is determined as an attack factor in the primary determination once, and the log is recorded, as illustrated in FIG. 12.

Then, the code verification is executed again, and if the verification fails as illustrated in FIG. 12 (a), the attack is confirmed, and if the verification is successful as illustrated in FIG. 12 (b), it is determined that the detected abnormality is due to erroneous detection in the secondary determination.

According to the present modification, it is possible to further distinguish between an attack and erroneous detection in addition to the distinction between an attack and a failure in the above-described embodiment.

Furthermore, the present invention can also be adopted in the aspects described below.
Correction of determination result using mechanism of two-sided ROM and memory protection function

The area in which the code verification program is stored is set as a two-surface memory (double bank) to ensure redundancy, and the determination result is corrected by utilizing the code verification result in the standby surface activation after the code verification of the activation surface fails. When the standby surface can be activated, a notification to a VSOC (vehicle security operation center) is attempted.
Adjustment of accuracy according to use frequency of out-of-vehicle service

Since the weight of the certainty of determination varies depending on the use frequency of the out-of-vehicle service (always used, once per day, once per week, once per month, once per year, once per several years), the accuracy of determination in a case where an out-of-vehicle service with a lower use frequency is used is increased.
Setting of determination method according to type of out-of-vehicle service and abnormal system log

For example, in a case where the out-of-vehicle service is a service related to update (write system) such as reprogramming, a fault of setting wrong data is added (ECU stores fault determination as a log in addition to attack/failure determination).
Considering vulnerability occurrence risk of out-of-vehicle service

The possibility of attack after use of OSS (open source software) in which many vulnerabilities are reported and use of services such as write system services is increased.
Setting of accuracy of closed log to host ECU to be high

Even in the failure system log, the communication system log is affected by the communication counterpart, so that the reliability depends on the ECU of the communication counterpart. On the other hand, since the monitoring results of the memory abnormality, the circuit abnormality, and the activation abnormality are closed in the ECU, the reliability is high. In addition, even in the attack log, the secure boot can realize closed determination in the ECU, whereas the other attack logs are affected by the opposite, and thus, the reliability gradually becomes opposite. In this manner, the accuracy can be changed depending on whether the event is closed in the monitoring target ECU, whether the opposite such as a communication counterpart, or the like is present.

According to the embodiment of the present invention described above, the following operational effects are obtained.
(1) A state determination device according to an embodiment of the present invention is a state determination device which determines an abnormal state of an electronic control device mounted on a vehicle, the state determination device including: an extra-vehicular communication monitoring unit which monitors a presence or an absence of communication between the electronic control device and an outside of the vehicle; a code verification unit which executes code verification of the electronic control device; a device abnormality monitoring unit which monitors occurrence or non-occurrence of abnormality of the electronic control device; and an abnormality factor determination unit which determines a factor of an abnormality, wherein the abnormality factor determination unit identifies a factor of the abnormality based on a presence or an absence of communication, a result of the code verification, and existence or non-existence of the abnormality.

With the above configuration, in a case where an abnormality occurs, it is possible to determine whether the factor is a failure or a cyberattack with a small number of man-hours, and it is possible to quickly and appropriately deal with the occurrence of the defect of the vehicle.
(2) In a case where the extra-vehicular communication monitoring unit determines that communication is present and the device abnormality monitoring unit determines that an abnormality has occurred in the electronic control device after occurrence of the communication, the abnormality factor determination unit determines that the abnormality is caused by an attack from an outside of the vehicle. As a result, first, the primary determination determines that it is an attack, and thus, it is possible to eliminate a risk that a delay occurs in handling and the damage expands.
(3) The code verification unit executes code verification of the electronic control device after the device abnormality monitoring unit determines that an abnormality has occurred in the electronic control device, and the abnormality factor determination unit corrects the abnormality as being caused by a failure of the electronic control device in a case where a result of the code verification indicates normal. As a result, even in a case where the primary determination determines as an attack, the secondary determination of a failure is immediately made, so that it is possible to quickly take an appropriate measure against the abnormality (failure).
(4) The code verification unit executes code verification of the electronic control device in a case where the extra-vehicular communication monitoring unit determines that communication is present, and the device abnormality monitoring unit does not determine that an abnormality has occurred in the electronic control device after occurrence of the communication, and the abnormality factor determination unit determines that an attack from an outside of the vehicle has been applied to the electronic control device in a case where a result of the code verification indicates abnormal. As a result, even in a case where no abnormality occurs in the monitoring target ECU, it is possible to quickly make determination of an attack by using highly reliable code verification.
(5) In a case where the extra-vehicular communication monitoring unit does not determine that communication is present, and the device abnormality monitoring unit determines that an abnormality has occurred in the electronic control device, the abnormality factor determination unit determines that the abnormality is caused by a failure of the electronic control device. As a result, it is not necessary to make an attack determination every time an abnormality occurs, and it is possible to take an appropriate and quick response to an event.
(6) The code verification unit executes code verification of the electronic control device in a case where the device abnormality monitoring unit determines that an abnormality has occurred in the electronic control device, and the abnormality factor determination unit determines that the abnormality is caused by a failure of the electronic control device or a physical attack from an outside in a case where a result of the code verification indicates abnormal. As a result, not only a failure but also a physical attack is considered as a possibility in the secondary determination, and it is possible to take prevention against the attack, for example.

Note that the present invention is not limited to the above embodiments, and various modifications are possible. For example, the above-described embodiments have been described in detail in order to simply describe the present invention, and are not necessarily limited to those having all the described configurations. Further, a part of the configuration of one embodiment can be replaced with the configuration of another embodiment. In addition, the configuration of another embodiment can be added to the configuration of a certain embodiment. In addition, a part of the configuration of each embodiment can be deleted, or another configuration can be added or replaced.

### REFERENCE SIGNS LIST

1 state determination device
12 extra-vehicular communication monitoring unit
13 code verification unit
14 device abnormality monitoring unit
15 abnormality factor determination unit

1. A state determination device which determines an abnormal state of an electronic control device mounted on a vehicle,
the state determination device comprising:
an extra-vehicular communication monitoring unit which monitors a presence or an absence of communication between the electronic control device and an outside of the vehicle;
a code verification unit which executes code verification of the electronic control device;
a device abnormality monitoring unit which monitors occurrence or non-occurrence of abnormality of the electronic control device; and
an abnormality factor determination unit which determines a factor of the abnormality,
wherein the abnormality factor determination unit identifies the factor of the abnormality based on a presence or an absence of communication, a result of the code verification, and existence or non-existence of the abnormality.

2. The state determination device according to claim 1,
wherein
in a case where the extra-vehicular communication monitoring unit determines that communication is present and the device abnormality monitoring unit determines that an abnormality has occurred in the electronic control device after occurrence of the communication, the abnormality factor determination unit determines that the abnormality is caused by an attack from an outside of the vehicle.

3. The state determination device according to claim 2,
wherein
the code verification unit executes code verification of the electronic control device after the device abnormality monitoring unit determines that an abnormality has occurred in the electronic control device, and
the abnormality factor determination unit corrects the abnormality as being caused by a failure of the electronic control device in a case where a result of the code verification indicates normal.

4. The state determination device according to claim 1,
wherein
the code verification unit executes code verification of the electronic control device in a case where the extra-vehicular communication monitoring unit determines that communication is present, and the device monitoring unit does not determine that an abnormality has occurred in the electronic control device after occurrence of the communication, and
the abnormality factor determination unit determines that an attack from an outside of the vehicle has been applied to the electronic control device in a case where a result of the code verification indicates abnormal.

5. The state determination device according to claim 1,
wherein
in a case where the extra-vehicular communication monitoring unit does not determine that communication is present, and the device abnormality monitoring unit determines that an abnormality has occurred in the electronic control device, the abnormality factor determination unit determines that the abnormality is caused by a failure of the electronic control device.

6. The state determination device according to claim 5,
wherein
the code verification unit executes code verification of the electronic control device in a case where the device abnormality monitoring unit determines that an abnormality has occurred in the electronic control device, and
the abnormality factor determination unit determines that the abnormality is caused by a failure of the electronic control device or a physical attack from an outside in a case where a result of the code verification indicates abnormal.
